(19) United States
(12) Patent Application Publication
(10) Pub. No.: US 2013/0162558 A1
(43) Pub. Date: Jun. 27, 2013

(54) ELECTRONIC DEVICE AND METHOD FOR SELECTIVELY SWITCHING OPERATION INTERFACES BETWEEN LEFT-HANDED MODE AND RIGHT-HANDED MODE

(71) Applicants: Fu Tai Hua Industry (Shenzhen) Co., Ltd., Shenzhen (CN); Hon Hai Precision Industry Co., Ltd., New Taipei (TW)

(72) Inventor: REN-WEN HUANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/693,042

(22) Filed: Dec. 4, 2012

(30) Foreign Application Priority Data
Dec. 21, 2011 (CN) 201110432412.9

(51) Int. Cl. G06F 3/041

(52) U.S. Cl. CPC G06F 3/0416
USPC 345/173

(57) ABSTRACT

An electronic device capable of selectively switching operation interfaces between a left-handed mode and a right-handed mode is provided. The electronic device includes a touch screen, a storage unit, a touch detecting unit, a processing unit and an interface switching unit. The storage unit stores a left-handed mode operation interface, a right-handed mode operation interface, and a corresponding relationship among a number of predetermined touch operations and the left-handed and right-handed mode operation interfaces. The touch detecting unit detects a touch operation on the touch screen. The processing unit outputs a switching signal if it determines that the detected touch operation matches a predetermined touch operation. The interface switching unit determines an intended operation interface corresponding to the detected touch operation, and switches the current operation interface to the intended operation interface corresponding to the detected touch operation, according to the switching signal. A related method is also provided.

### BACKGROUND

1. Technical Field

The present disclosure relates to an electronic device capable of selectively switching operation interfaces between a left-handed mode and a right-handed mode, and a method for selectively switching operation interfaces of the electronic device between a left-handed mode and a right-handed mode.

2. Description of Related Art

Existing portable electronic devices usually only have a right-handed operation interface. However, left-handed persons will feel uncomfortable when they use these electronic devices having only right-handed operation interface.

Therefore, an electronic device and a method for switching operation interfaces between a left-handed mode and a right-handed mode are needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device, according to an embodiment.

FIG. 2 is a schematic view showing how to manipulate the electronic device of FIG. 1 to switch to right-handed mode.

FIG. 3 is a schematic view showing how to manipulate the electronic device of FIG. 1 to switch to left-handed mode.

FIG. 4 is a flowchart illustrating a method for selectively switching operation interfaces of the electronic device of FIG. 1 between a left-handed mode and a right-handed mode.

### DETAILED DESCRIPTION

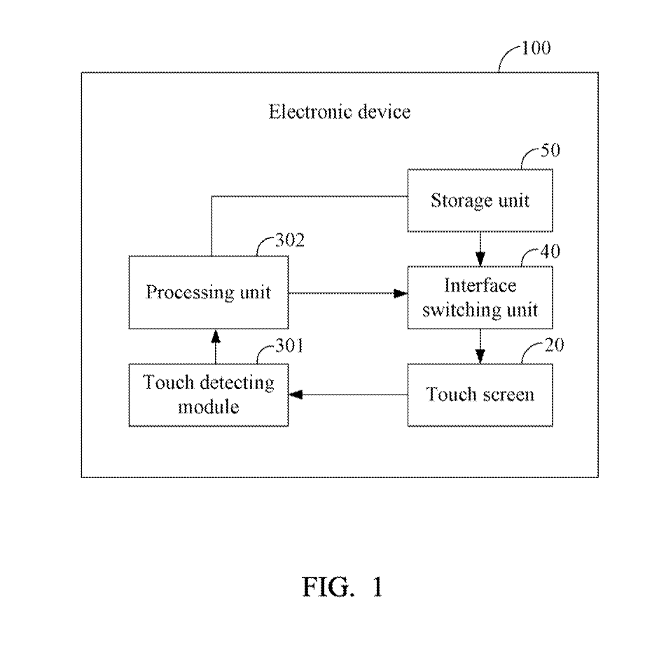

Referring to FIG. 1, an electronic device 100 capable of selectively switching operation interfaces between a left-handed mode and a right-handed mode is provided.

The electronic device 100 may be but is not limited to a mobile phone, a personal digital assistant, a notebook computer, or a tablet computer, for example. The electronic device 100 includes a touch screen 20, a touch detecting unit 301, a processing unit 302, an interface switching unit 40, and a storage unit 50.

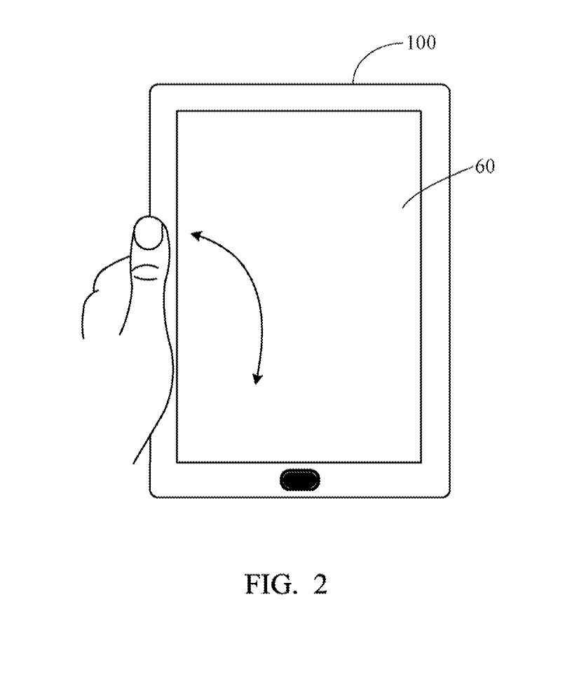

The touch screen 20 is configured for receiving touch input from users. The storage unit 50 stores operation interfaces including a left-handed mode operation interface and a right-handed mode operation interface, and a corresponding relationship among a number of predetermined touch operations and the left-handed and right-handed mode operation interfaces. In the embodiment, the predetermined touch operations include a first touch operation for switching to left-handed mode and a second touch operation for switching to right-handed mode. In an interface switching mode 60 as shown in FIG. 2, a user can input a predetermined touch operation such as a sliding action of a predetermined pattern to switch a current operation interface to a different operation interface.

The touch detecting unit 301 is connected to the touch screen 20, the touch detecting unit 301 is configured to detect touch operations by the user on the touch screen 20. The processing unit 302 is configured to determine whether the detected touch operation matches a predetermined touch operation stored in the storage unit 50, and output a switching signal if the detected touch operation matches a predetermined touch operation.

The interface switching unit 40 is configured for determining an intended operation interface corresponding to the detected touch operation, and switching the current operation interface to the intended operation interface corresponding to the detected touch operation, according to the switching signal.

Specifically, if the processing unit 302 determines that the detected touch operation matches the first touch operation for switching to left-handed mode, the interface switching unit 40 switches the current operation interface to the left-handed mode operation interface; if the processing unit 302 determines that the detected touch operation matches the second touch operation for switching to right-handed mode, the interface switching unit 40 switches the current operation interface to the right-handed mode operation interface. It should be noted that, if the current operation interface is the same as the one corresponding to the detected touch operation by the user, the interface switching unit 40 does not respond to the switching touch operation.

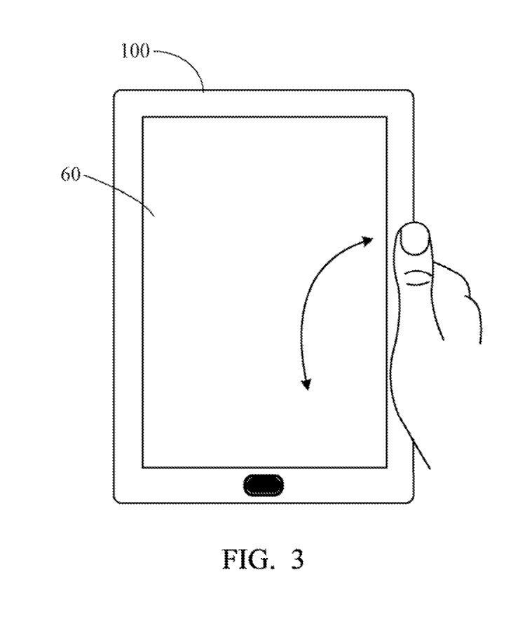

In the embodiment, users can define the predetermined touch operations stored in the storage unit 50, such as defining the first touch operation for switching to left-handed mode as a slide gesture towards the right or the left along a curved line, and defining the right-handed mode switching touch operation as a slide gesture towards the left or the right along a curved line. The operation interfaces of the device 100 can be conveniently switched by a user using their thumb tip of the same hand holding the device 100. As right-handed persons are used to holding the electronic device 100 with their left hands, and operate the electronic device 100 with their right hands, such as shown in FIG. 2. When in the interface switching mode 60, right-handed persons can then use their left thumb tip to draw an arc line with an opening facing left, to generate the second touch operation for switching to right-handed mode. Analogously, left-handed persons are used to holding the electronic device with their right hands, and operate the electronic device with their left hands, such as shown in FIG. 3, left-handed persons can use their right thumb tip to draw an arc line with an opening facing right, to generate the first touch operation for switching to left-handed mode.

It should be noted that, users can pre-define the left-handed mode switching touch operation as an up slide action or a down slide action, and pre-define the right-handed mode switching touch operation as a down slide action or an up slide action.

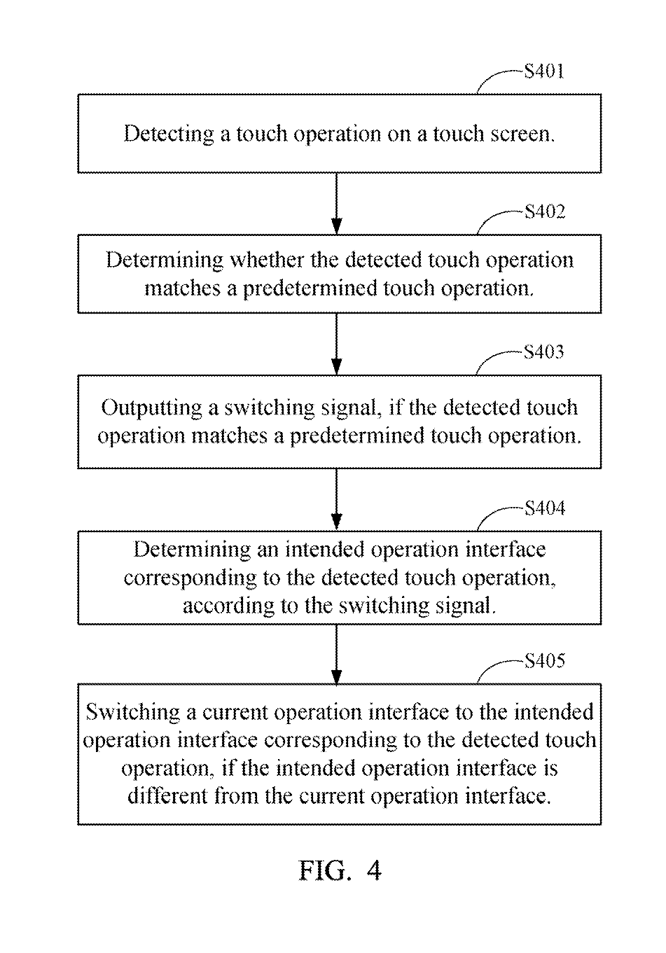

FIG. 4 is a flowchart illustrating a method for selectively switching operation interfaces between a left-handed mode and a right-handed mode.

In step S401, the touch detecting unit 301 detects a touch operation on the touch screen 20.

In step S402, the processing unit 302 determines whether the detected touch operation matches a predetermined touch operation.

In step S403, if the processing unit 302 determines that the detected touch operation matches a predetermined touch operation, the processing unit 302 outputs a switching signal.

In step S404, the interface switching unit 40 determines an intended operation interface corresponding to the detected touch operation, according to the switching signal.

In step S405, the interface switching unit 40 switches the current operation interface to the intended operation interface corresponding to the detected touch operation, if the intended operation interface is different from the current operation interface.

Thereby, the electronic device can be switched to display different mode operation interface, in order to meet different needs of different persons.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device capable of selectively switching operation interfaces between a left-handed mode and a right-handed mode, the electronic device comprising:
a touch screen;
a storage unit configured for storing operation interfaces comprising a left-handed mode operation interface and a right-handed mode operation interface, and a corresponding relationship among a number of predetermined touch operations and the left-handed and right-handed mode operation interfaces;
a touch detecting unit configured to detect a touch operation by a user on the touch screen,
a processing unit configured to determine whether the detected touch operation matches a predetermined touch operation stored in the storage unit, and output a switching signal if the detected touch operation matches a predetermined touch operation; and
an interface switching unit configured for determining an intended operation interface corresponding to the detected touch operation, and switching the current operation interface to the intended operation interface corresponding to the detected touch operation, according to the switching signal.

2. The electronic device as described in claim 1, wherein the predetermined touch operations comprises a first touch operation for switching to left-handed mode and a second touch operation for switching to right-handed mode.

3. The electronic device as described in claim 2, wherein the first touch operation for switching to left-handed mode is a slide gesture towards the right along a curved line, and the second touch operation for switching to right-handed mode is a slide gesture towards the left along a curved line.

4. The electronic device as described in claim 2, wherein the first touch operation for switching to left-handed mode is a slide gesture towards the left along a curved line, and the second touch operation for switching to right-handed mode is a slide gesture towards the right along a curved line.

5. A method for switching operation interfaces of an electronic device between a left-handed mode and a right-handed mode, the electronic device comprising a storage unit, the storage unit configured for storing operation interfaces comprising a left-handed mode operation interface and a right-handed mode operation interface, and a corresponding relationship among a number of predetermined touch operations and the left-handed and right-handed mode operation interfaces; the method comprising:
detecting a touch operation on a touch screen;
determining whether the detected touch operation matches a predetermined touch operation;
outputting a switching signal, if the detected touch operation matches a predetermined touch operation;
determining an intended operation interface corresponding to the detected touch operation, according to the switching signal; and
switching a current operation interface to the intended operation interface corresponding to the detected touch operation, if the intended operation interface is different from the current operation interface.

6. The method as described in claim 5, wherein the predetermined touch operations comprises a first touch operation for switching to left-handed mode and a second touch operation for switching to right-handed mode.

7. The method as described in claim 6, wherein the first touch operation for switching to left-handed mode is a slide gesture towards the right along a curved line, and the second touch operation for switching to right-handed mode is a slide gesture towards the left along a curved line.

8. The method as described in claim 6, wherein the first touch operation for switching to left-handed mode is defined as a slide gesture towards the left along a curved line, and the second touch operation for switching to right-handed mode is a slide gesture towards the right along a curved line.
